(19) United States
(12) Patent Application Publication
(10) Pub. No.: US 2010/0003424 A1
(43) Pub. Date: Jan. 7, 2010

(54) Method for repairing defect on substrate

(76) Inventor: Dae-Jeong Kim, Hwaseong town (KR)

Correspondence Address: MCKENNA LONG & ALDRIDGE LLP, 1900 K STREET, NW, WASHINGTON, DC, 20006, US

(21) Appl. No.: 12/289,979

(22) Filed: Nov. 7, 2008

(30) Foreign Application Priority Data
Jul. 2, 2008 (KR) 10-2008-0063875

(51) Int. Cl. B05D 3/12

(52) U.S. Cl. 427/595; 427/140

(57) ABSTRACT

A method for repairing a substrate includes injecting a restoration material onto a substrate including a defect, the restoration material covering the defect; hardening the restoration material; and abrading the hardened restoration material such that the hardened restoration material and the substrate form a flat top surface.

The present invention claims the benefit of Korean Patent Application No. 10-2008-0063875 filed in Korea on Jul. 2, 2008, which is hereby incorporated by reference for all purposes as if fully set forth herein.

### BACKGROUND OF THE INVENTION

1. Field of the Invention

The present invention relates to a method for repairing a defect on a substrate, and more particularly, to a method for repairing a defect on a substrate by injecting a restoration material into a defect portion.

2. Discussion of The Related Art

The cathode ray tube (CRT) device, which has been a widely used display device, is used as a television, a monitor for a measuring device and an information terminal. However, as properties, such as, smaller size and lighter weight of the display device are required, there are limitation for the CRT device because of its heavy weight and large size. To overcome these limitations of the CRT device, many types of flat panel display devices (FPDs), such as liquid crystal display (LCD) devices, plasma display panels (PDPs), field emission display (FED) devices, electroluminescence display (ELD) devices, and so on, have been introduced. The FPDs is fabricated using a transparent glass substrate.

Since the LCD devices among the FPDs have excellent capabilities of a thin profile, light weight and low power consumption, they are widely used. Particularly, the LCD device including a thin film transistor, as a switching element, is widely used for notebook computers, monitors, TV, etc., because of its high contrast ratio, high quality image and characteristics adequate to display moving images.

The LCD device includes a liquid crystal panel and a backlight unit. The liquid crystal panel includes an array substrate, a color filter substrate and a liquid crystal layer therebetween. Each of the array substrate and the color filter substrate includes a transparent glass substrate. In the array substrate, a gate line on the transparent glass substrate crosses a data line on the transparent glass substrate to define a pixel region. In addition, a thin film transistor (TFT) at each crossing portion of the gate and data lines is connected to a pixel region in each pixel region. On the other hand, a color filter layer including sub-color filters of red, green and blue colors, a black matrix corresponding to boundaries of each pixel region, and a common electrode on the color filter layer and the black matrix are formed on the transparent glass substrate of the color filter substrate.

Moreover, a liquid crystal panel driving unit including a driving circuit for providing a driving signal is electrically connected to one side of the liquid crystal panel. The liquid crystal panel driving unit provides signals to the gate and data lines to drive the liquid crystal panel. By controlling voltages of a data signal applied into the pixel electrode with a common electrode having a common voltage, the liquid crystal molecules in the liquid crystal layer are rotated due to an optical anisotropy of the liquid crystal molecules depending on an electric field induced between the pixel and common electrodes. As a result, the LCD devices can display images by controlling light transmissivity.

In a fabricating process of the array substrate and the color filter substrate, there are defects, such as scratches and dents, on a surface of the transparent glass substrate. The transparent glass substrate may be repaired by abrading an entire surface thereof. However, the transparent glass substrate is discarded when the defect is too deep.

Hereinafter, the related art repairing method for a defect on the substrate is explained.

FIGS. 1A and 1B are cross-sectional views of the related art liquid crystal panel having a defect, respectively. In FIGS. 1A and 1B, the liquid crystal panel 10 includes an array substrate 12, a color filter substrate 14 and a liquid crystal layer 16 therebetween. For example, when the liquid crystal panel 10 is modulated with a case (not shown), there may be a defect 18, such as scratches and dents, on a surface of the transparent glass substrate of the array substrate 12 or the color filter substrate 14. Since the defect 18 on the transparent glass substrate cause problems in displaying images, the defect 18 is required to be removed. Referring to FIG. 1A, the defect 18 having a first depth “b” is formed on the transparent glass substrate of the array substrate 12. By abrading an entire surface of the transparent substrate of the array substrate 18 by a first thickness “b”, which is substantially the same as the first depth “b”, using an abrasion unit (not shown), the transparent substrate is repaired. By the abrading process, a new surface 20 is exposed, and a new transparent glass substrate has a second thickness “a”. Since the transparent substrate should be abraded to have the second thickness “a”, the processing time increases. In addition, additional apparatuses for the abrading process are required.

On the other hand, referring to FIG. 1B, when the defect 18 has a second deep “d”, which is much greater than the first deep “b”, there are further problems. Namely, to repair the transparent glass substrate having the defect 18, the transparent glass substrate should be abraded for the transparent glass substrate to have a second thickness “c”. In this case, because the transparent glass substrate is too thin, the transparent glass substrate may not be used. In addition, when the defect 18 is too deep, it is impossible to repair the transparent glass substrate by the related art repairing method. As a result, the liquid crystal panel may be discarded such that a production yield is reduced.

Furthermore, since an entire surface of the transparent glass substrate including the defect should be abraded in the related art repairing process, the processing time further increases.

### SUMMARY OF THE INVENTION

Accordingly, the present invention is directed to a method for repairing a defect on a substrate that substantially obviates one or more of the problems due to limitations and disadvantages of the related art.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

To achieve these and other advantages and in accordance with the purpose of the invention, as embodied and broadly described, a method for repairing a substrate includes injecting a restoration material onto a substrate including a defect, the restoration material covering the defect; hardening the restoration material; and abrading the hardened restoration material such that the hardened restoration material and the substrate form a flat top surface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principle of the invention. In the drawings:

FIGS. 1A and 1B are cross-sectional views of the related art liquid crystal panel having the defect, respectively;

FIGS. 2A to 2F are cross-sectional views showing a repairing process of a defect on a substrate according to the present invention;

FIGS. 3A to 3C respectively show kinds of defect on a substrate;

FIGS. 4A and 4B are pictures respectively showing a surface of a substrate before and after a method for repairing a defect on the substrate according to the present invention; and

FIG. 5 is a cross-sectional view showing a process of abrading a restoration material on a substrate according to the present invention.

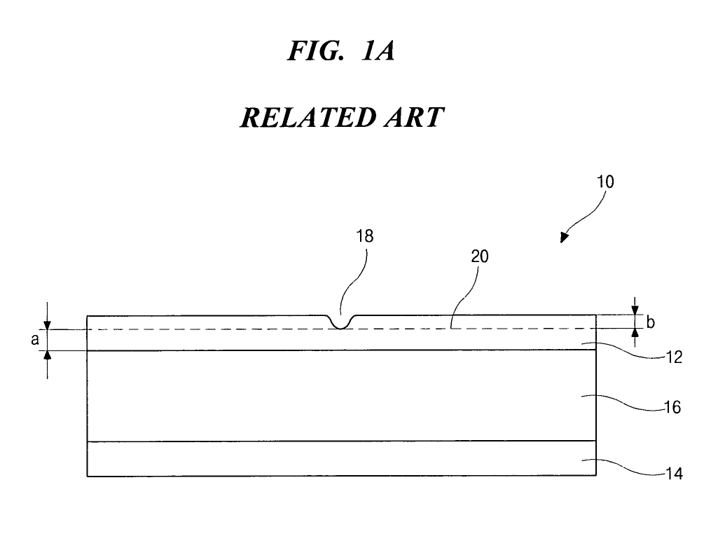

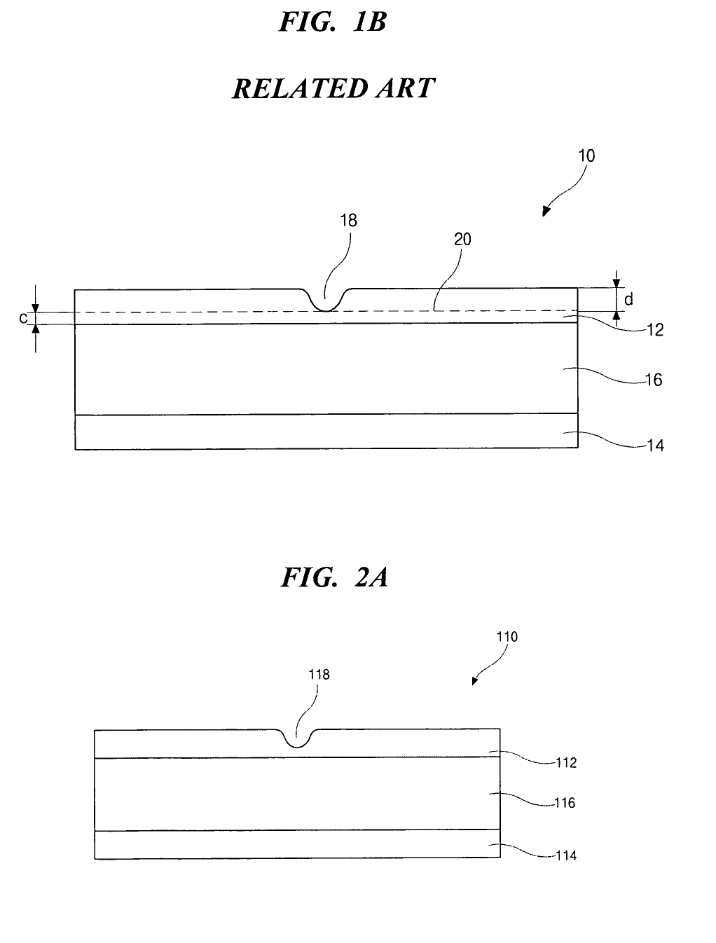

### DETAILED DESCRIPTION OF THE ILLUSTRATED EMBODIMENTS

Reference will now be made in detail to exemplary embodiments of the invention, which are illustrated in the accompanying drawings.

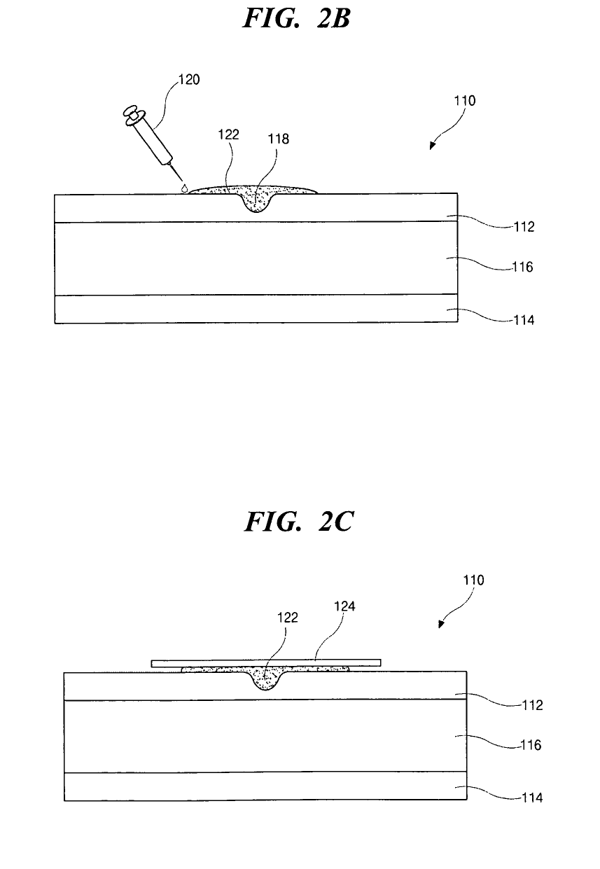

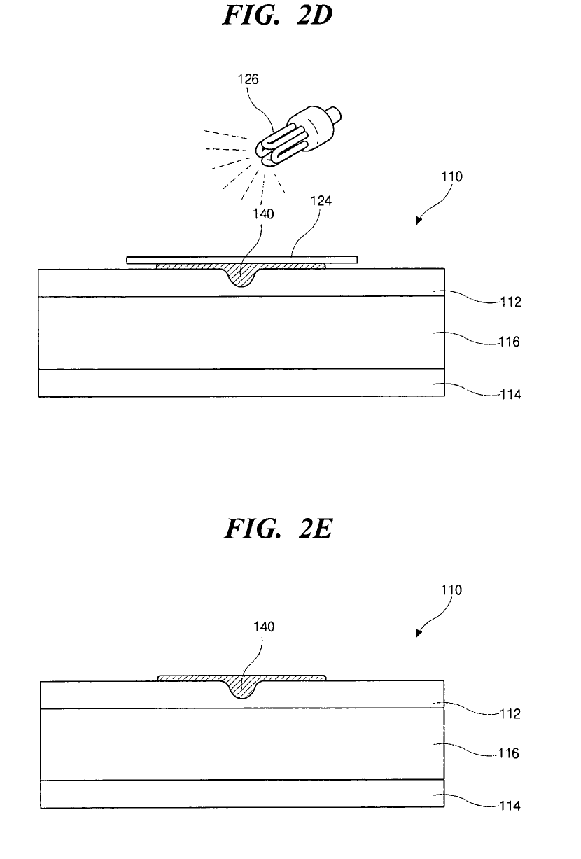

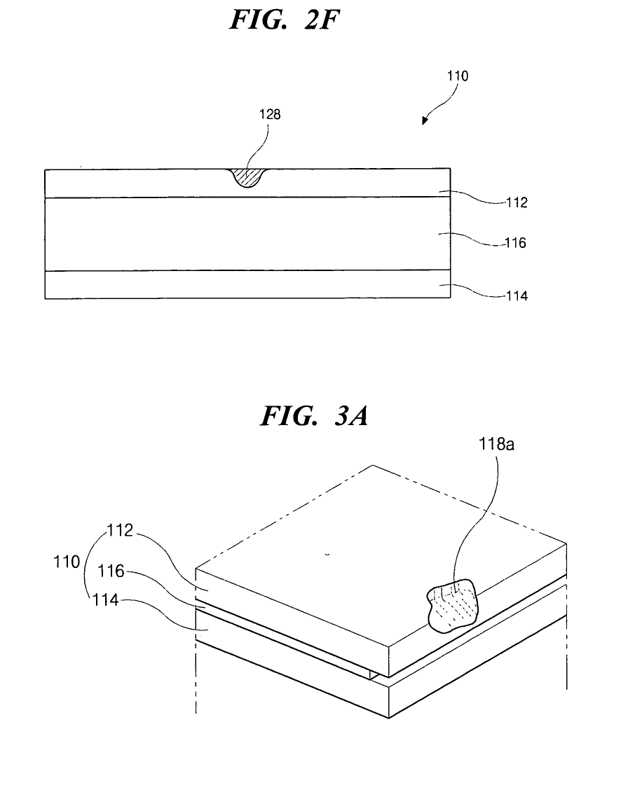

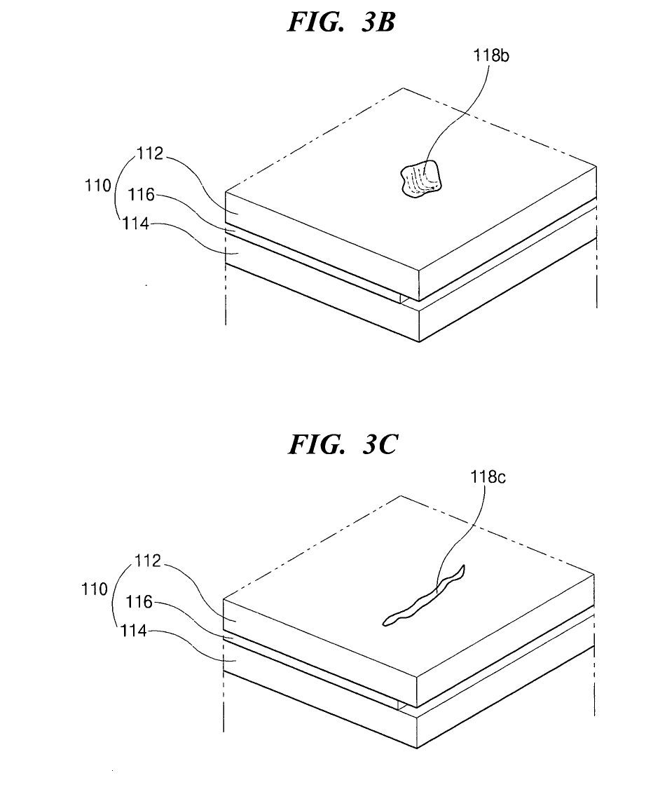

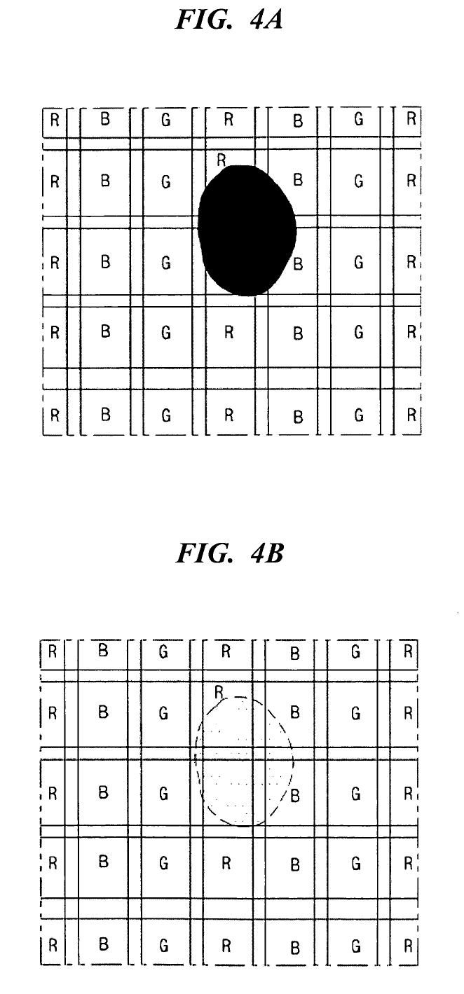

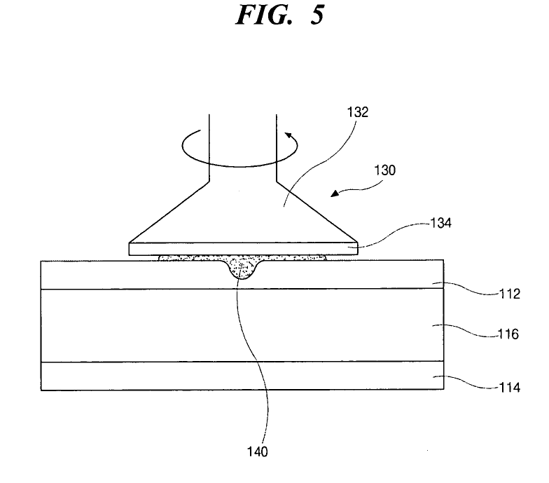

FIGS. 2A to 2F are cross-sectional views showing a repairing process of a defect on a substrate according to the present invention, FIGS. 3A to 3C respectively show types of defect on a substrate, FIGS. 4A and 4B are pictures respectively showing a surface of a substrate before and after a method for repairing a defect on the substrate according to the present invention, and FIG. 5 is a cross-sectional view showing a process of abrading a restoration material on a substrate according to the present invention.

As shown in FIGS. 3A to 3C, a liquid crystal panel 110 includes the array substrate 112, a color filter substrate 114 and a liquid crystal layer 116 therebetween. Defects 118a, 118b and 118c are generated on a substrate of an array substrate 112 during a fabricating process of the liquid crystal panel 110. The defects may be generated on a substrate of the color filter substrate 114. The substrate may be formed of a transparent glass. Referring to FIG. 3A, the edge defect 118a is disposed at an edge of the substrate. Referring to FIG. 3b, the dent defect 118b may be generated by being pressed by a case (not shown) used for modulating the liquid crystal panel 110. Referring to FIG. 3C, the scratch defect 118c may be generated by being scratched by a case (not shown) used for modulating the liquid crystal panel 110.

Each of the edge defect 118a and the dent defect 180b may have a diameter of about 0.2 millimeters to about 1 centimeter. The scratch defect 118c may have a width of about 0.2 millimeters and a length of about 10 centimeters. Although each of the edge defect 118a, the dent defect 118b and the scratch defect 118c is small when compared to an entire surface area of the liquid crystal panel, the defects 118a, 118b and 118c may cause a serious problem in displaying images. Accordingly, the defects 118a, 118b and 118c should be repaired. If it is impossible to repair the defects 118a, 118b and 118c, the substrate in which the defects 118, 118b and 118c are generated should be discarded. To be considered a productive yield, it is strongly required to repair the defects 118a, 118b and 118c.

The liquid crystal panels are classified into repair-necessary goods and repair-unnecessary goods according to a size of the liquid crystal panel and a depth of the defect 118. A small sized liquid crystal panel smaller than a 10-inch model is classified considering a depth of a defect above about 0.1 millimeters or not. Accordingly, when the defect on a substrate of a small size liquid crystal panel has a depth below 0.1 millimeters, the liquid crystal panel is classified into the repair-unnecessary goods such that the liquid crystal panel is used for an LCD device without a repair process. On the other hand, when the defect on a substrate of a small size liquid crystal panel has a depth above 0.1 millimeters, the liquid crystal panel is classified into the repair-necessary goods such that the liquid crystal panel is used for an LCD device after a repair process.

A large sized liquid crystal panel larger than 10 inch model is classified considering a depth of a defect above about 0.2 millimeters or not. Accordingly, when the defect on a substrate of a large size liquid crystal panel has a depth below 0.2 millimeters, the liquid crystal panel is classified into the repair-unnecessary goods such that the liquid crystal panel is used for an LCD device without a repair process. On the other hand, when the defect on a substrate of a large size liquid crystal panel has a depth above 0.2 millimeters, the liquid crystal panel is classified into the repair-necessary goods such that the liquid crystal panel is used for an LCD device after a repair process.

Referring to FIGS. 2A to 2F, a method for repairing a defect on a substrate according to the present invention is explained. It is assumed that a defect is generated on a substrate of an array substrate of a liquid crystal panel.

In FIG. 2A, a substrate 112 where a defect 118 is generated is cleaned to remove particles thereon. As mentioned above, the liquid crystal panel 110 includes a substrate 112, as an array substrate, a substrate 114, as a color filter substrate, and a liquid crystal layer 116 therebetween.

Next, in FIG. 2B, a restoration material 122 is injected into the defect 118 using an injection unit 120. The restoration material 122 is injected onto a periphery of the defect 118 as well as the defect 118. The restoration material 122 may include an acrylic resin being transparent and having a high fluidity. In addition, the acrylic resin in the restoration material 122 is quickly hardened by ultraviolet (UV) light. The restoration material 122 is different from a material of the substrates 112 and 114. The restoration material 122 has contents and a ratio thereof in Table 1.

TABLE 1

| Contents | Weight % |
|---|---|
| 2-hydroxyethyl methacrylate | 70-80 |
| isobornyl methacrylate | 10-20 |
| triethylene glycol dimethacrylate | 0.1-5 |
| photoininitiator | 0.1-3 |
| acrylic acid | 0.1-3 |

The restoration material 122 may be a windshield repair, for example, a KIT of Liquid Resin International, Ltd., or a bullseye windshield repair KIT of Permatex, Inc.

Next, in FIG. 2C, a transparent film 124 is attached to the substrate 112 where the restoration material 122 is injected. The transparent film 124 contacts the restoration material 122 and corresponds to the defect 118. The transparent film 124 functions as a buffer when there is an outer press for the restoration material 122 to be completely penetrated into the defect 118. In addition, the transparent film 124 prevents the contents of the restoration material 122 from being volatilized by blocking an exposure of the restoration material 122 in the air. The transparent film 124 may be a cellophane film. The transparent film 124 has a larger size than the defect 118. The transparent film 124 also covers a region where the restoration material 122 is formed.

Next, in FIG. 2D, the UV light is irradiated onto the transparent film 124 using a UV lamp 126, as a hardening unit, to harden the restoration material 122 (of FIG. 2C). As a result, a hardened restoration material 140 is formed in the defect 118. The UV lamp 126 emits the UV light having a light intensity of about 3 mW/cm² during a period of about 3 minutes to about 5 minutes. Since an amount of irradiated light is a multiplication of the light intensity by an irradiating time, a minimum amount of irradiated light onto the restoration material 122 for hardening is about 540 mJ. The UV light from the UV lamp 126 should not affect the liquid crystal layer 116 of the liquid crystal panel 110. If an opaque film is used instead of the transparent film 124, the restoration material 122 can not be hardened by the UV light. Accordingly, when an opaque film is used instead of the transparent film 124, a heat hardening unit instead of the UV lamp 126 is used to harden the restoration material 122.

Next, in FIG. 2E, after removing the transparent film 124 (of FIG. 2D), the hardened restoration material 140 is abraded. By the abrading process on the hardened restoration material 140, the restored portion 128 forms a flat top surface with the substrate 112, as shown in FIG. 2F. Since the hardened restoration material 140 has a smaller hardness degree than the substrate 112, there is no damage on the substrate 112 during the abrading process on the hardened restoration material 140 with an abrading unit (not shown) having a hardness degree smaller than a hardness degree of the substrate 112 and greater than a hardness degree of the hardened restoration material 140. The hardened restoration material 140 may be scrapped off from the substrate 112 to form a flat top surface using a razor. A hardness degree of the razor is smaller than a hardness degree of the substrate 112 and greater than a hardness of the hardened restoration material 140.

FIG. 5 is a cross-sectional view showing a process of abrading a restoration material on a substrate according to the present invention. In FIG. 5, an abrading unit 130 includes a body 132 and an abrading cloth 134 disposed under the body 132. The body 132 is rotatable. The abrading cloth 134 is combined with the body 132 such that the abrading cloth 134 is rotated when the body 132 is rotated. A slurry (not shown), which is capable of abrading the hardened restoration material 140 in physical and chemical, is coated on the abrading cloth 134. The slurry does not affect the substrate 112. The abrading unit 130 is rotated and closed to the substrate 112. The abrading unit 130 contacts and abrades the hardened restoration material 140 such that the hardened restoration material 140 and the substrate 112 form a flat top surface. Then, by cleaning the restored portion 128 using isopropyl alcohol (IPA), the repairing process is finished.

In FIGS. 3B and 3C, the dent defect 118b and the scratch defect 118c are disposed at a center of a surface of the substrate 112. Accordingly, the defects 118b and 118c can be restored by the above repairing process including an injection process of the restoration material, a hardening process of the restoration material, and an abrading process of the hardened restoration material. However, in FIG. 3A, the above repairing process is performed on a top surface, as well as, a side surface to restore the edge defect 118a disposed at an edges of the substrate 112. In this case, the restoration material 122 is injected onto the substrate 112 to cover a portion of the top surface of the substrate 112 and a portion of the side surface of the substrate 112. The transparent film 124 is attached to cover the restoration material 122 on the portion of the top surface of the substrate 112 and the portion of the side surface of the substrate 112. Then, the restoration material 122 is hardened to form the hardened restoration material 140, and the transparent film 124 is detached. After detaching the transparent film 124, the hardened restoration material 140 is abraded.

FIGS. 4A and 4B are pictures respectively showing a surface of a substrate before and after a method for repairing a defect on the substrate according to the present invention. In FIG. 4A, the defect is distinctly observed such that the LCD device has poor image quality with a substrate where the defect is formed. However, in FIG. 4B, there is no image problem due to the repairing process according to the present invention. The repairing process can be applied to a single substrate.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for repairing a substrate, comprising:
injecting a restoration material onto a substrate including a defect, the restoration material covering the defect;
hardening the restoration material; and
abrading the hardened restoration material such that the hardened restoration material and the substrate form a flat top surface.

2. The method according to claim 1, further comprising attaching a film onto the restoration material after injecting the restoration material and before hardening the restoration material and detaching the film after the step of hardening the restoration material and before abrading the hardened restoration material.

3. The method according to claim 2, wherein the film is a transparent cellophane film.

4. The method according to claim 3, wherein hardening the restoration material includes irradiating an ultraviolet light onto the restoration material.

5. The method according to claim 4, wherein the ultraviolet light has a light intensity of about 3 mW/cm2 and an irradiating duration time of about 3 minutes to about 5 minutes.

6. The method according to claim 1, wherein the restoration material is hardened by a heat.

7. The method according to claim 1, wherein the hardened restoration material is abraded by an abrading unit having a hardness degree smaller than a hardness degree of the substrate and greater than a hardness degree of the hardened restoration material.

8. The method according to claim 7, wherein the abrading unit includes a razor.

9. The method according to claim 7, wherein the abrading unit includes a rotatable body and an abrading cloth coupled with the body.

10. The method according to claim 1, further comprising cleaning the substrate after abrading the hardened restoration material.

11. The method according to claim 10, wherein the substrate is cleaned using isopropyl alcohol.

12. The method according to claim 1, wherein the restoration material consists of 2-hydroxyethyl methacrylate, isobornyl methacrylate, triethylene glycol dimethacrylate, photoininitiator and acrylic acid.

13. The method according to claim 12, wherein the 2-hydroxyethyl methacrylate has about 70 to about 80 weight %, the isobomyl methacrylate has about 10 to about 20 weight %, the triethylene glycol dimethacrylate has about 0.1 to about 5 weight %, the photoininitiator has about 0.1 to about 3 weight % and the acrylic acid has about 0.1 to about 3 weight %.

14. The method according to claim 1, wherein the defect has a depth above about 0.1 millimeters when the substrate is smaller than a 10 inch model substrate.

15. The method according to claim 1, wherein the defect has a depth above about 0.2 millimeters when the substrate is lager than a 10 inch model substrate.
